(19) United States
(12) Patent Application Publication
(10) Pub. No.: US 2016/0188508 A1
(43) Pub. Date: Jun. 30, 2016

(54) MULTIPLEX MODULE AND ELECTRONIC APPARATUS THEREOF FOR HIGH-SPEED SERIAL TRANSMISSION

(71) Applicant: REALTEK SEMICONDUCTOR CORP., HSINCHU (TW)

(72) Inventor: Ming-Hui Tung, Hsinchu City (TW)

(21) Appl. No.: 14/701,573

(22) Filed: May 1, 2015

(30) Foreign Application Priority Data
Dec. 24, 2014 (TW) 103145346

(51) Int. Cl. G06F 13/362; G06F 13/42; G06F 13/40

(52) U.S. Cl. CPC G06F 13/362; G06F 13/4068; G06F 13/4282; G06F 13/4022

(57) ABSTRACT

A multiplex module for high-speed serial transmission is provided. The multiplex module has at least one external connection terminal and at least one circuit connection terminal. The multiplex module includes a multiplexer and at least one resistor. The multiplexer includes a plurality of switches and each switch has a first end and a second end. The at least one resistor is coupled to the multiplexer. The at least one resistor is respectively coupled to the external connection terminal. The first end of each switch is coupled to the at least one external connection terminal, and the second end of each switch is coupled to the at least one circuit connection terminal. The multiplexer is configured to operatively switch among a plurality of signal links for conducting a signal transmission. The resistor is configured to correspondingly cancel a reflecting signal reflected from the external connection terminal during the signal transmission.

### BACKGROUND

1. Technical Field

The present disclosure relates to a multiplex module, in particular to a multiplex module and an electronic apparatus for high-speed serial transmission.

2. Description of Related Art

As technology rapidly develops, the information or data transmission speed plays an important role. In a wired high-speed communication transmission system, it is necessary to have a multiplexer placed on the signal transmission path when signal selection operation is needed to be executed.

Please refer to FIG. 1, which shows a diagram illustrating a conventional high-speed serial transmission system. A high-speed serial transmission system 1 includes a multiplexer 10, a transmitting circuit block 11, and a receiving circuit block 12. The multiplexer 10 is coupled to the transmitting circuit block 11. The receiving circuit block 12 is coupled to the multiplexer 10. More specifically, the transmitting circuit block 11 and the receiving circuit block 12 are respectively disposed in different devices or apparatuses, and configured to perform signal transmission in a wired manner.

In an ideal situation, the signal strength of a receiving signal received by the receiving circuit block 12 and the signal strength of a transmitting signal transmitted from a first transmitting terminal TXO₁ or a second transmitting terminal TXO₂ of the transmitting circuit block 11 should be the same. For example, when the multiplexer 10 selects the first transmitting terminal TXO₁ of the transmitting circuit block 11 to transmit a transmitting signal S1, the signal strength of a receiving signal S2 correspondingly received at a receiving terminal RXI₁ of the receiving circuit block 12 ideally should be equal to the signal strength of the transmitting signal S1. However, in practice, the multiplexer 10 generates impedance during on/off operation, which causes the signal strength of the transmitting signal S1 to be attenuated as the transmitting signal S1 passes through the multiplexer 10.

More specifically, during high-speed signal transmission, signals generally are already distorted or attenuated while pass through the circuit or the cable. Thus, the transmission speed, the signal strength, or even the signal integrity of the signal transmission will be attenuated again by the impedance of an external component disposed on the signal transmission path. In other words, the impedance of the external component disposed therefore becomes a stumbling block to the transmission speed of the high-speed serial system 1.

### SUMMARY

An exemplary embodiment of the present disclosure provides a multiplex module for high-speed serial transmission, having at least one external connection terminal and at least one circuit connection terminal. The multiplex module includes a multiplexer and at least one resistor. The multiplexer includes a plurality of switches and each switch has a first end and a second end. The at least one resistor is coupled to the multiplexer. The at least one resistor is respectively coupled to the at least external connection terminal. The first end of each switch is coupled to at least one external connection terminal, and the second end of each switch is coupled to at least one circuit connection terminal. The multiplexer is operable to switch among a plurality of signal links for conducting a signal transmission. The resistor is configured to correspondingly cancel a reflecting signal reflected from the respective external connection terminal during the signal transmission.

An exemplary embodiment of the present disclosure provides an apparatus for high-speed serial transmission. The apparatus includes a multiplex module and a signal processing module. The multiplex module has at least one external connection terminal and at least one circuit connection terminal. The multiplex module includes a multiplexer and at least one resistor. The multiplexer includes a plurality of switches having a first end and a second end. The signal processing module couples to the multiplex module. The at least one resistor couples to the multiplexer. The at least one resistor is respectively coupled to the at least one external connection terminal. The first end of each switch couples to at least one external connection terminal, and the second end of each switch couples to at least one circuit connection terminal. The multiplexer is operable to switch among a plurality of signal links for conducting a signal transmission. The resistor is configured to correspondingly cancel a reflecting signal reflected at the external connection terminal during the signal transmission. The signal processing module is configured for generating a transmitting signal or processing a receiving signal received during the signal transmission.

To sum up, a multiplex module and an electronic apparatus provided by the present disclosure for high-speed serial transmission can effectively prevent signal attenuation issue in the conventional method resulting from multiplexing among the apparatuses. More specifically, the exemplary embodiment of the present disclosure processes the signal after switching transmission links and thus prevents the signal attenuation caused by the impedance of the multiplexer disposed on the signal transmission path and maintains the signal integrity. In short, the present disclosure can effectively resolve the signal attenuation issue in the conventional high-speed transmission and achieve the objectives of enhancing bandwidth and reducing signal loss at same time.

In order to further understand the techniques, means and effects of the present disclosure, the following detailed descriptions and appended drawings are hereby referred to, such that, and through which, the purposes, features and aspects of the present disclosure can be thoroughly and concretely appreciated, however, the appended drawings are merely provided for reference and illustration, without any intention that they be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a diagram illustrating a conventional high-speed serial transmission system.

FIG. 2 is a diagram illustrating a high-speed serial transmission system provided according to an exemplary embodiment of the present disclosure.

FIG. 3 is a diagram illustrating a transmitting circuit block of a multiplex module provided according to the exemplary embodiment of the present disclosure.

FIG. 4 is a diagram illustrating a receiving circuit block of the multiplex module provided according to the exemplary embodiment of the present disclosure.

FIG. 5 is a diagram illustrating a transmitting circuit block of a multiplex module provided according to another exemplary embodiment of the present disclosure.

FIG. 6 is a diagram illustrating a receiving circuit block of the multiplex module provided according to another exemplary embodiment of the present disclosure.

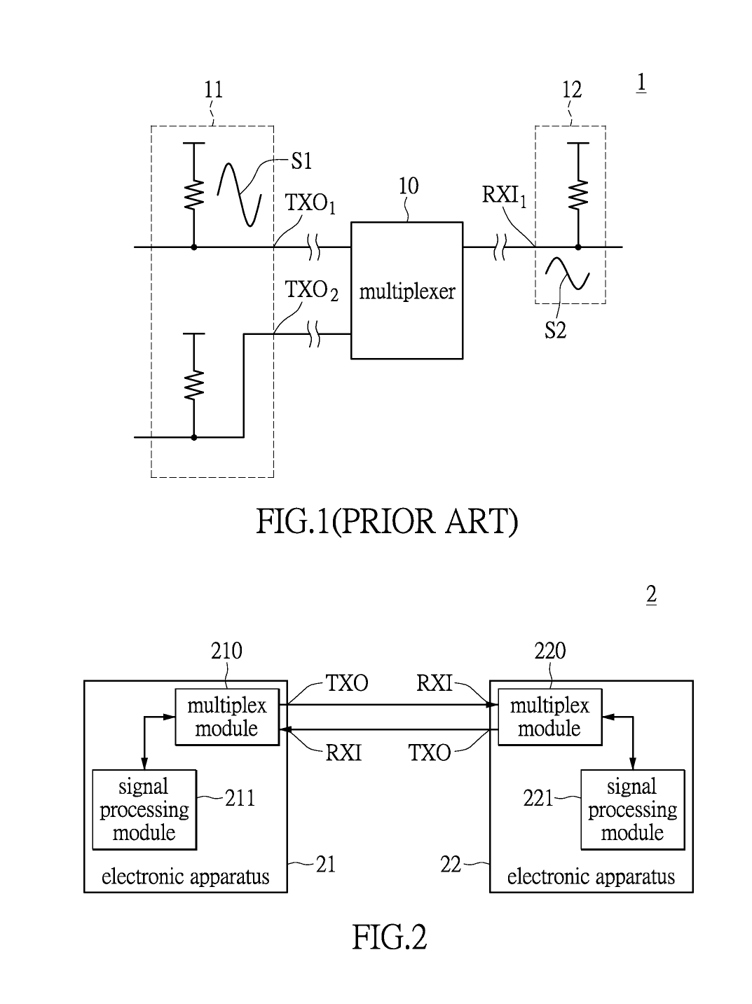

### DESCRIPTION OF THE EXEMPLARY EMBODIMENTS

Reference will now be made in detail to the exemplary embodiments of the present disclosure, examples of which are illustrated in the accompanying drawings. However, they may be embodied in different forms and should not be construed as limited to the embodiments set forth herein. In the accompanying drawings, the relative thickness of layers and regions may be exaggerated for clarity. Wherever possible, the same reference numbers are used in the drawings and the description to refer to the same or like parts.

Exemplary embodiments of the present disclosure utilize circuitry implementation and effectively suppress signal attenuation to a transmission signal during signal transmission caused by the multiplexer employed in a conventional high-speed transmission system. The exemplary embodiments of the present disclosure are illustrated as following.

Please refer to FIG. 2, which shows a diagram illustrating a transmitting circuit block of a multiplex module provided according to an exemplary embodiment of the present disclosure. The high-speed serial system 2 includes electronic apparatuses 21 and 22. Each of the electronic apparatuses 21 and 22 has a transmitting interface TXO and a receiving interface RXI. The electronic apparatus 21 includes a multiplex module 210 and a signal processing module 211. The electronic apparatus 22 includes a multiplex module 220 and a signal processing module 221. The signal processing module 211 is coupled to the multiplex module 210. The signal processing module 221 is coupled to the multiplex module 220. The transmitting interface TXO of the electronic apparatus 21 in the instant embodiment is coupled to the receiving interface RXI of the electronic apparatus 22 in a wired manner (i.e., via a cable connection). In one embodiment of the present disclosure, each electronic apparatus 21 and 22 has at least one transmitting terminal at the transmitting interface TXO and at least one receiving terminal at the receiving interface RXI.

It is worth to mention that the high-speed serial system 2 shown in FIG. 2 is a bidirectional transmission system. However, the present disclosure is not limited thereto. For example, the high-speed serial system 2 in another embodiment may be implemented as a single-directional transmission system by either removing the transmitting interface TXO from the electronic apparatus 22 and the receiving interface RXI from the electronic apparatus 21, or removing the transmitting interface TXO from the electronic apparatus 21 and the receiving interface RXI from the electronic apparatus 22.

Each of the electronic apparatuses 21 and 22 communicates with one another in a wired manner via the multiplex modules 210 and 220 for data exchange (e.g., exchanging command or data). The electronic apparatuses 21 and 22 are structurally independent or separate devices. Each one of the electronic apparatuses 21 and 22 may be integrated or coupled to another electronic device external thereto, such as a personal computer, a server, an electronic apparatus for automobile, or any other device employing wire transmission. In the instant embodiment, the electronic apparatus 21 can be a portable hard drive, a tablet, a laptop or the like. The electronic apparatus 22 may be a flash drive, a burner, a printer, or a display. However, any person skilled in the art should understand that the instant embodiment, without any intention to limit the scope of the present disclosure thereto, can be utilized and applied to any other transmission system.

Each one of the signal processing modules 211 and 221 comprises necessary logics, circuitries, and/or codes. More specifically, each one of the signal processing modules 211 and 221 comprises at least one circuit connection terminal electrically connected to other circuit components. In the electronic apparatus 21, either the signal processing module 211 has at least one transmitting circuit terminal at the transmitting circuit interface thereof for operatively transmitting a transmitting signal to the at least one transmitting terminal at the transmitting interface TXO coupling to the multiplex module 210 to perform signal transmission, or the signal processing module 211 has at least one receiving circuit terminal at the receiving interface thereof for operatively receiving a receiving signal received from the at least one receiving terminal at the receiving interface RXI coupling the multiplex module 210. The operation of the signal processing module 211 is essentially the same as the operation of the signal processing module 221, thus further description is hereby omitted.

Each one of the multiplex modules 210 and 220 comprises necessary logics, circuitries, and/or codes for exchanging data with each other. The multiplex module 210 of the electronic apparatus 21 is coupled to the signal process module 211. The multiplex module 210 is also coupled to the transmitting interface TXO and the receiving interface RXI for conducting signal transmission. In an exemplary embodiment, where the multiplex module 210 of the electronic apparatus 21 is connected to the cable, the multiplex module 210 can through transmitting a test signal there through determine the resistance or the capacitance of the reflecting signal from the cable and correspondingly generate a control signal controlling the switching operation of a multiplexer 2101 (not illustrated). In practice, the multiplex module 210 may be implemented via hardware or software for determining the electrical impedance of the cable. The present disclosure is not limited thereto. Moreover, in the instant embodiment of the present disclosure, the operation of the multiplex module 210 is essentially the same as the operation of the multiplex module 220, thus further description is omitted hereto.

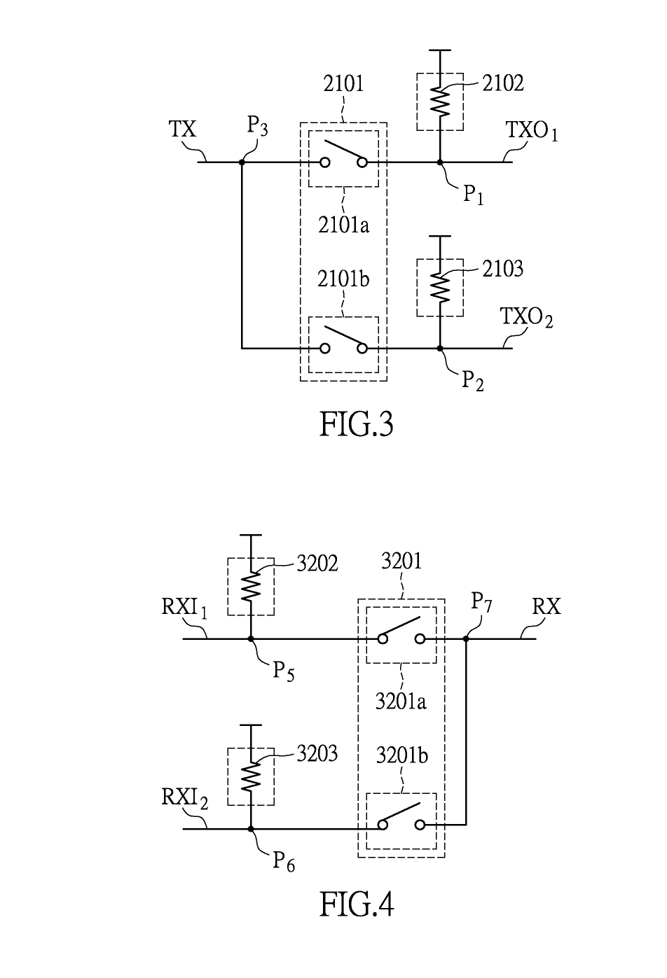

Details regarding the circuitry of the multiplex module 210 are illustrated as following. Please refer to FIG. 3 in conjunction with FIG. 2, wherein FIG. 3 shows a diagram illustrating a transmitting circuit block of a multiplex module provided according to an exemplary embodiment of the present disclosure. The instant embodiment takes the transmitting circuit block being disposed in the electronic apparatus 21 as an example for illustration. The multiplex module 210 has a first external connection terminal P1, a second external connection terminal P2, and a first circuit connection terminal P3, and the multiplex module 210 further includes a multiplexer 2101 and resistors 2102, 2103. The multiplexer 2101 includes switches 2101a and 2101b.

The multiplexer 2101 is operable to switch among a plurality of signal links for enabling the electronic apparatus 21 to conduct signal transmission. Each of the switches 2101a and 2101b has a first end and a second end. The resistor 2102 and the first end of the switch 2101a are coupled to the first external connection terminal P1. The resistor 2103 and the first end of the switch 2101b of the multiplexer 2101 are coupled to the second external connection terminal P2. More specifically, the first end of the switch 2101a is coupled to a first transmitting terminal TXO₁ of the transmitting interface TXO through the first external connection terminal P1 of the multiplex module 210. The first end of the switch 2101b is coupled to a second transmitting terminal TXO₂ of the transmitting interface TXO through the second external connection terminal P2 of the multiplex module 210. Additionally, the second end of each switch 2101a, 2101b is coupled to the first circuit connection terminal P3, in particular, the second end of the switch 2101a and the second end of the switch 2101b are coupled to the first circuit connection terminal P3 through the transmitting circuit terminal TX, which is the radiating circuit terminal of the transmitting circuit interface in the signal process module 211.

It is worth to mention that both the first transmitting circuit terminal TX₁ and the second transmitting circuit terminal TX₂ in the instant embodiment of the present disclosure may be implemented with USB 3.1 type-C standard. More specifically, the appearances of the upper part and the lower part of the connector (such as the transmitting interface TXO or the receiving interface RXI) under the USB 3.1 type-C standard are the same and cannot be distinguished, thus, the signals received by the electronic apparatus 21 or 22 may be erroneous when the signal links has not been switched, accordingly. Thus, when detects that the transmitting interface TXO of the electronic apparatus 21 connects to the cable through the multiplex module 210, the multiplex module 210 operatively transmits a test signal to detect the channel resistance or the channel capacitance of the cable, so as to determine whether the data signal shall be transmitted by the first transmitting circuit terminal TX₁ or the second transmitting circuit terminal TX₂. However, it should be understand by those skilled in the art that the first transmitting circuit terminal TX₁ or the second transmitting circuit terminal TX₂ in other embodiments can be implemented as one of a USB terminal, a PCIe terminal, a DisplayPort terminal, or a SAS/SATA terminal.

In the instant embodiment of the present disclosure, the multiplexer 2101 switches to one of a plurality of signal links via switches 2101a, 2101b to enable the electronic apparatus 21 to conduct signal transmission. The single links described herein may include the link formed between the transmitting circuit terminal TX, the switch 2101a, and the first transmitting terminal TXO₁, or the link formed between the transmitting circuit terminal TX, the switch 2101b, and the second transmitting terminal TXO₂.

Additionally, each one of the resistors 2102, 2103 is a terminal resistor, and is configured to cancel a reflecting signal reflected from the first external connection terminal P1 or the second external connection terminal P2, respectively while the multiplex module 210 performing signal transmission. More specifically, the resistors 2102 and 2103 in the instant embodiment are 50 ohm resistors selected in accordance with the USB 3.1 type-C standard. However, any person skilled in the art should know that the resistors 2102, 2103 in other embodiment may each be also selected based on the design and/or application needs, and therefore the present disclosure is not limited thereto.

Please refer to FIG. 4 in conjunction with FIG. 2, wherein FIG. 4 shows a diagram illustrating a receiving circuit block of the multiplex module provided according to the exemplary embodiment of the present disclosure. The receiving circuit block is placed in the electronic apparatus 22 as an illustration example. The multiplex module 220 has a first external connection terminal P5, a second external connection terminal P6, and a first circuit connection terminal P7. The multiplex module includes a multiplexer 3101 and resistors 3202, 3203. The multiplexer 3201 includes switches 3201a and 3201b.

Similarly, in correspondence to the aforementioned multiplexer 2101 of the transmitting circuit block disposed in the electronic apparatus 21, the multiplexer 3201 is also operable to switch among the plurality of signal links to enable the electronic apparatus 22 to conduct signal transmission. The switch 3201a of the multiplexer 3201 has a first end and a second end. The first end of the switch 3201a and the resistor 3202 are coupled to the first external connection terminal P5. The switch 3201b of the multiplexer 3201 has a first end and a second end. The resistor 3203 is coupled to the second external connection terminal P6. In detail, the first end of the switch 3201a is coupled to a first receiving terminal RXI₁ of the receiving interface RXI through the first external connection terminal P5 of the multiplex module 220. The first end of the switch 3201b is coupled to a first receiving terminal RXI₂ of the receiving interface RXI through the second external connection terminal P6 of the multiplex module 220. Additionally, the second end of each switch 3201a, 3201b of the multiplexer 3201 is coupled to the first circuit connection terminal P7. More specifically, the second ends of the switches 3201a, 3201b are respectively coupled to the receiving circuit terminal RX (e.g., the receiving circuit terminal at the receiving circuit interface of the signal process module 221) through the first circuit connection terminal P7 of the multiplex module 220.

Similarly, the first receiving terminal RXI₁ and the second receiving terminal RXI₂ in the instant embodiment is implemented with USB 3.1 type-C standard. When the receiving interface RXI of the electronic apparatus 22 connects to the cable, the multiplex module 220 determines whether the multiplex module 210 conducts signal transmission with the first transmitting circuit terminal TX₁ or the second transmitting circuit terminal TX₂ according to the test signal received from the multiplex module 210 In another embodiment, each of the first receiving terminal RXI₁ and the second receiving terminal RXI₂ also can be implemented as one of the USB terminal, the PCIe terminal, the DisplayPort terminal, and the SAS/SATA terminal, based on the exact type or the exact implementation of the first transmitting terminal TXO₁ and the second transmitting terminal TXO₂ of the electronic apparatus 21.

It can be obviously observed that the circuitry structure of the transmitting circuit block is symmetric to that of the receiving circuit block as depicted in FIG. 3 and FIG. 4. More specifically, the multiplexer 2101 is disposed between the first transmitting terminal TXO₁ (or the second transmitting terminal TXO₂) and the transmitting circuit terminal TX, and the multiplexer 3201 is disposed between the first receiving terminal RXI₁ (or the second receiving terminal RXI₂) and the receiving circuit terminal RX.

In short, the instant embodiment of the present disclosure provides a 2-to-1 transmission channel selection means for the high-speed communication transmission system 2 to conduct signal transmission by configuring the respective transmitting and receiving circuit blocks as shown FIG. 3 and FIG. 4 such that the signal link switching operation is performed before signal transmission. Thus, signals transmitted between the electronic apparatuses 21 and 22 will not be attenuated by the impedance of conventional multiplexer placed on transmission path, and the signal strength as well as the signal integrity of the signal transmitted can be thereby enhanced. For example, the signal strength of signal received at the receiving circuit block of the multiplex module 220 in the electronic apparatus 22 will be close to the signal strength of signal being transmitted at the transmitting circuit block of the multiplex module 210 in the electronic apparatus 21. However, although the multiplexers 2101, 3201 are illustrated herein are 2-to-1 multiplexers, any persons skilled in the art should understood that the multiplexers 2101, 3201 may be implemented by 3-to-1 or multiple-to-1, hence the present disclosure is not limited thereto.

Moreover, please refer to FIG. 2, the multiplex modules 210, 220 may each be configured or designed to include the transmitting circuit block of FIG. 3 and the receiving circuit block of FIG. 4. It should be understood that even though the present disclosure illustrates placing the transmitting circuit block in the multiplex module 210 and the receiving circuit block in the multiplex module 220, however the present disclosure is not limited thereto.

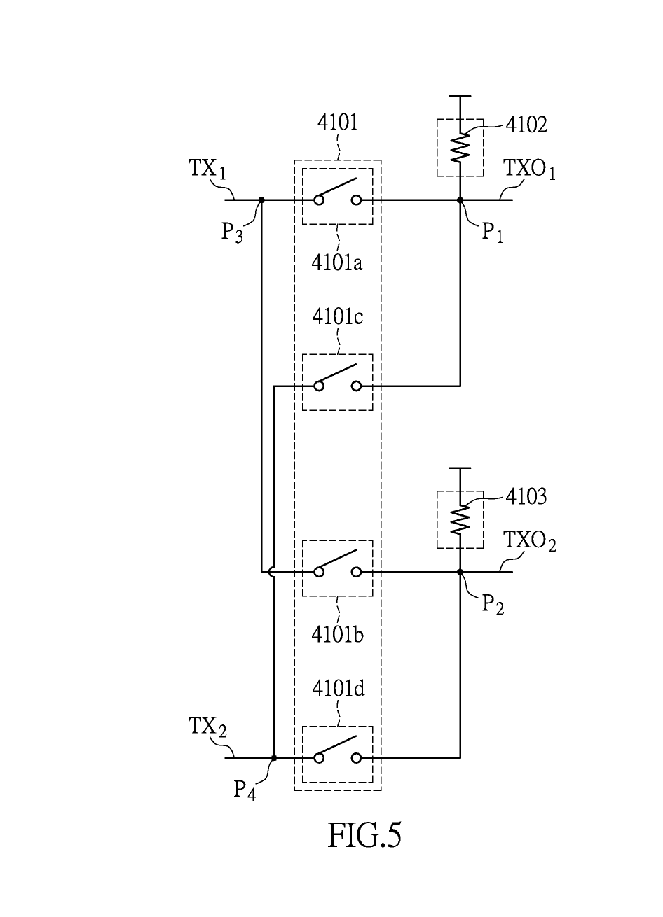

Another embodiment of the present disclosure is illustrated as following. Please refer to FIG. 5 in conjunction with FIG. 2, wherein FIG. 5 shows a diagram illustrating a transmitting circuit block of a multiplex module provided according to another exemplary embodiment of the present disclosure. The transmitting circuit block in the instant embodiment similar to previous embodiment is placed in the electronic apparatus 21, and the multiplex module 210 has a first external connection terminal P1, a second external connection terminal P2, a first circuit connection terminal P3 and a second circuit connection terminal P4. The multiplex module 210 includes a multiplexer 4101 and resistors 4102, 4103. The multiplexer 4101 further includes switches 4101a, 4101b, 4101c, and 4101d.

The multiplexer 4101 is operable to switch among a plurality of signal links in such a manner that enables the electronic apparatus 21 to conduct signal transmission. Each of the switches 4101a, 4101b, 4101c, and 4101d has a first end and a second end. The resistor 4102, the first end of the switch, and the first end of the switch 4101c are coupled to the first external connection terminal P1 of the multiplex module 210. The first end of the switch 4101b, the first end of the switch 4101d, and the resistor 4103 are coupled to the second external connection terminal P2 of the multiplex module 210. More specifically, the first end of the switch 4101a and the first end of the switch 4101c are coupled to a first transmitting terminal TXO₁ of the transmitting interface TXO through the first external connection terminal P1. The first end of the switch 4101b and the first end of the switch 4101d are coupled to a second transmitting terminal TXO₂ of the transmitting interface TXO through the second external connection terminal P2.

Additionally, the second end of each switch 4101a, 4101b is coupled to the first circuit connection terminal P3. The second end of each switch 4101c, 4101d is coupled to the second circuit connection terminal P4. More specifically, the second ends of the switches 4101a, 4101b are coupled to the first transmitting circuit terminal TX₁ (e.g., one of the transmitting circuit terminals at the transmitting circuit interface of the signal process module 211) through the first circuit connection terminal P3 of the multiplex module 210. The second ends of the switches 4101c, 4101d are coupled to the second transmitting circuit terminal TX₂ (e.g., another one of the transmitting circuit terminals at the transmitting circuit interface of the signal process module 211) through the second circuit connection terminal P4.

Each one of the first transmitting circuit terminal TX₁ and the second transmitting circuit terminal TX₂ in the instant embodiment can be implemented as a USB terminal, a PCIe terminal, a Display Port terminal, or a SAS/SATA terminal. For example, the first transmitting circuit terminal TX₁ may be configured as the USB terminal while the second transmitting circuit terminal TX₂ may be configured as the PCIe terminal.

It is worth noting that in the instant embodiment of the present disclosure, the multiplexer 4101 includes a plurality of link groups. More specifically, the multiplexer 4101 includes a first link group and a second link group. The first link group includes a first link formed of the first transmitting circuit terminal TX₁, the switch 4101a, and the first external connection terminal P1 and a second link formed of the second transmitting circuit terminal TX₂, the switch 4101d, and the second external connection terminal P2. The second link group includes a third link formed of the first transmitting circuit terminal TX₁, the switch 4101b, and the second external connection terminal P2, and a fourth link formed of the second transmitting circuit terminal TX₂, the switch 4101c, and the first external connection terminal P1.

The switches 4101a and 4101d are respectively controlled by a first control signal for causing the multiplex module 210 to select the first link group. The switches 4101b and 4101c are respectively controlled by a second control signal for causing the multiplex module 210 to select the second link group. In other words, the multiplex module 210 correspondingly selects and switches between the first link group and the second link group according to the first control signal and the second control signal. More specifically, as described in the aforementioned embodiment, when the transmitting interface TXO of the electronic apparatus 21 connects to the cable, the multiplex module 210 operatively transmits a test signal via the transmitting interface TXO, and determines the resistance or the capacitance of the reflecting signal reflected from the cable to correspondingly generate the first control signal or the second control signal controlling the switching and linking operation of the multiplexer 4101.

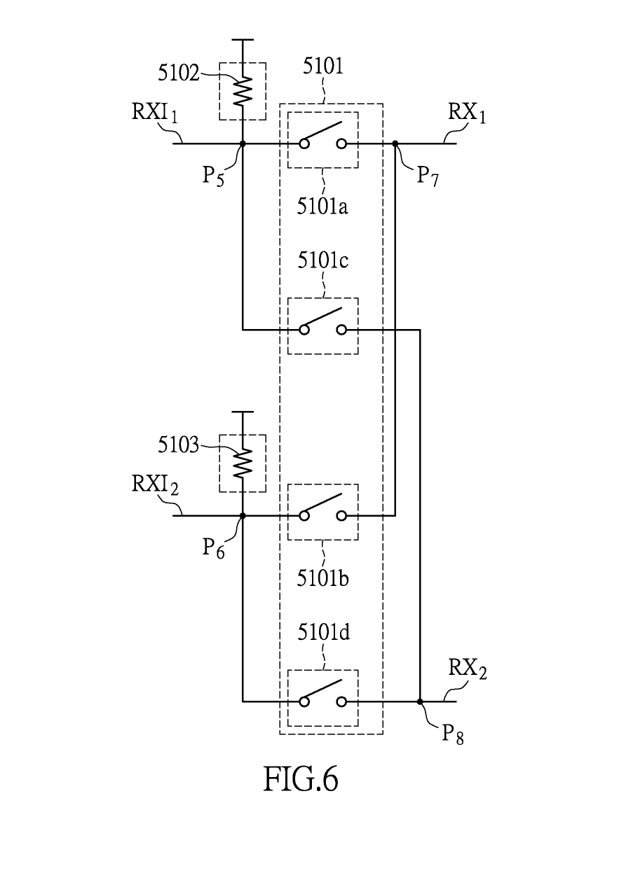

Please refer to FIG. 6 in conjunction with FIG. 2, which shows a diagram illustrating a receiving circuit block of the multiplex module provided according to another exemplary embodiment of the present disclosure. The receiving circuit block similar to the previous embodiment is placed in the electronic apparatus 22, and the multiplex module 210 has a first external connection terminal P5, a second external connection terminal P6, a first circuit connection terminal P7 and a second circuit connection terminal P8. The further includes a multiplexer 5101 and the resistors 5102, 5103. The multiplexer 5101 includes switches 5101a, 5101b, 5101c, and 5101d.

The multiplexer 5101 is operable to switch among a plurality of signal links in such a manner that enables the electronic apparatus 22 to conduct signal transmission. Each of the switches 5101a, 5101b, 5101c, and 5101d has a first end and a second end. The resistor 5102, the first end of the switch 5101a, and the first end of the switch 5101c are coupled to the first external connection terminal P5 of the multiplex module 210. The resistor 5103, the first end of the switch 5101b, and the first end of the switch 5101d are coupled to the second external connection terminal P6 of the multiplex module 210. More specifically, the first end of the switch 5101a and the first end of the switch 5101c are coupled to a first receiving terminal RXI₁ of the receiving interface RXI through the first external connection terminal P5. The switch 5101b and the first end of the switch 5101d are coupled to a second receiving terminal RXI₂ of the receiving interface RXI through the second external connection terminal P6.

Additionally, the second end of each switch 5101a, 5101b is coupled to the first circuit connection terminal P7. The second end of each switch 5101c, 5101d is coupled to the second circuit connection terminal P8. More specifically, the second ends of the switches 5101a, 5101b are coupled to the first receiving circuit terminal RX₁ (e.g., one of the receiving circuit terminals at the receiving circuit interface of the signal process module 211) through the first circuit connection terminal P7. The second ends of the switches 5101c, 5101d are coupled to the second receiving circuit terminal RX₂ (e.g., another one of the receiving circuit terminals at the receiving circuit interface of the signal process module 211) through the second circuit connection terminal P8.

The multiplexer 5101 in the instant embodiment is similar to the previous embodiment and also includes a plurality of link groups. More specifically, the multiplexer 5101 includes a third link group and a fourth link group. The third link group includes a fifth link formed of the first external connection terminal P5, the switch 5101a, and the first receiving circuit terminal RX₁, and a sixth link formed of the second external connection terminal P6, the switch 5101d, and the second receiving circuit terminal RX₂. The fourth link group includes a seventh link formed of the second external connection terminal P6, the switch 5101b, and the first receiving circuit terminal RX₁, and an eighth link formed of the first external connection terminal P5, the switch 5101c, and the second receiving circuit terminal RX₂.

The switches 5101a and 5101d are respectively controlled by a third control signal for causing the multiplex module 220 to select the third link group. The switches 5101b and 5101c are respectively controlled by a fourth control signal for causing the multiplex module 220 to select the fourth link group. In other words, the multiplex module 220 correspondingly selects and switches between the third link group and the fourth link group according to the third control signal and the fourth control signal. When the receiving interface RXI of the electronic apparatus 22 connects to the cable, the multiplex module 220 operatively generates the third control signal or the fourth control signal to control the multiplexer 5101 to switch among the link groups based on the test signal outputted from the multiplex module 210 to correspondingly conduct signal transmission.

Each one of the first receiving terminal RXI₁ and the second receiving terminal RXI₂ in the instant embodiment can be implemented as the USB terminal, the PCIe terminal, the DisplayPort terminal, or the SAS/SATA terminal. It is worth noting that each of the first receiving terminal RXI₁ and the second receiving terminal RXI₂ respectively corresponds to each of the first transmitting terminal TXO₁ and the second transmitting terminal TXO₂ of the electronic apparatus 21. For example, supposing the first transmitting terminal TXO₁ and the second transmitting terminal TXO₂ of the multiplex module 210 are respectively implemented by the USB terminal and the PCIe terminal, then the first receiving terminal RXI₁ and the second receiving terminal RXI₂ of the multiplex module 230 should be respectively implemented by the USB terminal and the PCIe terminal.

In short, the instant embodiment of the present disclosure provides a 2-to-2 transmission channel selection means for the high-speed communication transmission system 2 to conduct signal transmission by configuring the respective transmitting and receiving circuit blocks as shown FIG. 5 and FIG. 6 such that the signal link switching operation is performed before signal transmission. the instant embodiment illustrated a 2-to-2 transmission channel selection, however, any persons skilled in the art should understood that the concept provided herein may be extend to 3-to-3 or multiple-to-multiple transmission channel selection based on the needs and the present disclosure is not limited thereto.

It is worth noting that although the aforementioned embodiments are illustrated using the transmitting/receiving terminal and the transmitting/receiving circuit terminal, however those skilled in the art should be able to understand that the concept of the embodiments can also be apply to the transceiver terminals or the transceiver circuit terminals, and the present disclosure is not limited thereto.

To sum up, the multiplex module and an electronic apparatus provided by the present disclosure for high-speed serial transmission can effectively prevent the signal attenuation issue in the conventional method resulting from multiplexing among the apparatuses. More specifically, the exemplary embodiment of the present disclosure processes the signal after switching transmission links and thus prevents the signal attenuation caused by the impedance of the multiplexer disposed on the signal transmission path and maintains the signal integrity. In short, the present disclosure can effectively resolve the signal attenuation issue in the conventional high-speed transmission and achieve the objectives of enhancing bandwidth and reducing signal loss at same time.

Additionally, the multiplex module provided by the exemplary embodiment of the present disclosure is operable to determine transmission signal and to select and switch to transmission links accordingly for conforming to the USB 3.1 type-C standards. It is worth noting that the present disclosure also can be used with other transmission standards such as USB, PCIe, DisplayPort, or SAS/SATA, or even used with signal transmission of multi-standard.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A multiplex module for high-speed serial transmission, having at least one external connection terminal and at least one circuit connection terminal, the multiplex module comprising:
a multiplexer, operable to switch among a plurality of signal links for conducting a signal transmission, the multiplexer comprising:
a plurality of switches, each switch having a first end coupled to the at least one external connection terminal, and a second end coupled to the at least one circuit connection terminal; and
at least one resistor coupled to the multiplexer, the at least one resistor configured to respectively connect the at least one external connection terminal, and the resistor configured to correspondingly cancel a reflecting signal reflected from the respective external connection terminal during the signal transmission.

2. The multiplex module according to claim 1, wherein the multiplex module comprises a first external connection terminal coupled to a first transceiving terminal, a second external connection terminal coupled to a second transceiving terminal, and a first circuit connection terminal coupled to a first circuit terminal.

3. The multiplex module according to claim 2, wherein the multiplex module comprises a first resistor and a second resistor, and the switches comprise a first switch and a second switch, wherein the first resistor and a first end of the first switch are respectively coupled to the first external connection terminal, the second resistor and a first end of the second switch are respectively coupled to the second external connection terminal, and a second end of the first switch and a second end of the second switch are respectively coupled to the first circuit connection terminal.

4. The multiplex module according to claim 2, wherein the first and second transceiving terminals are USB 3.1 Type-C terminals.

5. The multiplex module according to claim 2, wherein the multiplex module further comprises a second circuit connection terminal coupled to a second circuit terminal.

6. The multiplex module according to claim 5, wherein the multiplex module comprises a first resistor and a second resistor, a first end of a first switch of the switches, a first end of a third switch of the switches, and the first resistor are coupled to the first external connection terminal, a first end of a second switch of the switches, a first end of a fourth switch of the switches, and a second resistor are coupled to the second external connection terminal, a second end of the first switch and a second end of the second switch are coupled to the first circuit connection terminal, and a second end of the third switch and a second end of the fourth switch are coupled to the second circuit connection terminal.

7. The multiplex module according to claim 6, wherein the first switch and the fourth switch are controlled by a first control signal and the second switch and the third switch are controlled by a second control signal, wherein the first control signal and the second control signal are configured to control the switching operation among a plurality of link groups.

8. The multiplex module according to claim 7, wherein a first link group of the link groups comprises a first link formed of the first circuit terminal, the first switch, and the first external connection terminal and a second link formed of the second circuit terminal, the fourth switch, the second external connection terminal; a second link group of the link groups comprises a third link formed of the first circuit terminal, the second switch, the second external connection terminal and a fourth link formed of the second circuit terminal, the third switch, the first connection terminal.

9. The multiplex module according to claim 5, wherein each of the first and the second transceiving terminals is a USB terminal, a PCIe terminal, a DisplayPort terminal, or a SAS/SATA terminal.

10. The multiplex module according to claim 1, wherein the resistance of the at least one resistor is 50 ohm.

11. An electronic apparatus for high-speed serial transmission, comprising:
a multiplex module for high-speed serial transmission, having at least one external connection terminal and at least one circuit connection terminal, comprising:
a multiplexer operable to switch among a plurality of signal links for conducting a signal transmission, the multiplexer comprising:
a plurality of switches, each switch having a first end coupled to the at least one external connection terminal, and a second end coupled to the at least one circuit connection terminal; and
at least one resistor coupled to the multiplexer, the at least one resistor configured to respectively connect the at least one external connection terminal, and the resistor configured to correspondingly cancel a reflecting signal reflected from the respective external connection terminal during the signal transmission; and
a signal processing module coupled to the multiplex module, the signal processing module configured for generating a transmitting signal or processing a receiving signal received during the signal transmission.
